(19) United States
(12) Patent Application Publication
(10) Pub. No.: US 2019/0218382 A1
(43) Pub. Date: Jul. 18, 2019

(54) METHOD OF MANUFACTURING A RESIN COMPOSITION

(71) Applicant: ASAHI KASEI KABUSHIKI KAISHA, Tokyo (JP)

(72) Inventors: Mihoko YAMAMOTO, Tokyo (JP); Nozomi INAGAKI, Tokyo (JP)

(73) Assignee: ASAHI KASEI KABUSHIKI KAISHA, Tokyo (JP)

(21) Appl. No.: 16/364,515

(22) Filed: Mar. 26, 2019

Related U.S. Application Data
(63) Continuation of application No. 15/408,738, filed on Jan. 18, 2017.

(30) Foreign Application Priority Data
Aug. 29, 2016 (JP) 2016-167004

(51) Int. Cl. C08L 23/12

(52) U.S. Cl. CPC C08L 23/12; C08L 2205/03

(57) ABSTRACT

A method of manufacturing a resin composition is provided. The resin composition includes: 100 parts by mass in total of (A) polypropylene-based resin and (B) polyphenylene ether resin; 1 part to 20 parts by mass of (C) an admixture; and 0.01 parts to 0.5 parts by mass of (D) one or more compounds selected from the group consisting of a higher fatty acid, a higher fatty acid metal salt, and a higher fatty acid ester. A proportion X_{D(B+C)} of the component (D) present in a whole fraction of 100 mass % dissolved in the chloroform is 0.13 mass % to 0.80 mass %. The method includes a step of melt-kneading the whole component (B), the whole component (C), and 15 mass % to 100 mass % of the component (D) to obtain kneaded material, and a step of adding the whole component (A) and the rest of the component (D).

### CROSS-REFERENCE TO RELATED APPLICATIONS

This application is a continuation of U.S. application Ser. No. 15/408,738 filed Jan. 18, 2017, which claims priority based on Japanese Patent Application No. 2016-167004 filed Aug. 29, 2016. The disclosures of the prior applications are hereby incorporated by reference herein in their entirety.

### TECHNICAL FIELD

The disclosure relates to a method of manufacturing a resin composition.

### BACKGROUND

Polypropylene-based resin is a low-specific-gravity and inexpensive plastic excellent in chemical resistance, solvent resistance, molding processability, and the like, and so is used in automobile components, electrical and electronic equipment components, home appliances, etc.

Polyphenylene ether resin is known as an engineering plastic excellent in flame retardance, heat resistance, dimensional stability, non-water absorbability, and electrical property, but has the drawbacks of not only poor melt fluidity and low molding processability but also low solvent resistance and low impact resistance.

Various compositions that combine the advantages of polypropylene-based resin and polyphenylene ether resin to compensate for their shortcomings have been proposed. For example, Patent Literatures (PTLs) 1 to 4 propose techniques for improving mechanical strength.

In detail, the proposed techniques are: a technique of using high crystallinity polypropylene-based resin and medium crystallinity polypropylene-based resin at a specific ratio (PTL 1); a technique of using a hydrogenated block copolymer having a specific structure as an admixture of polypropylene-based resin and polyphenylene ether resin (PTL 2); a technique of, when melt-kneading polypropylene-based resin and polyphenylene ether resin, adding the polypropylene-based resin to the melt of the polyphenylene ether resin and an admixture and further melt-kneading them (PTL 3); and a technique of adding a polyamine compound and an acrylate compound in order to reduce thermally deteriorating material generated during melt kneading (PTL 4).

### CITATION LIST

### Patent Literatures

PTL 1: JP H9-12799 A
PTL 2: JP H9-12804 A
PTL 3: JP H9-302167 A
PTL 4: JP 2010-138215 A

### SUMMARY

Resin compositions for use in secondary battery cases and the like have been required to have better thermal creep resistance, toughness, etc.

In detail, resin compositions employed as, for example, the material of secondary battery cases, etc. often used in harsh environments including high-temperature environments such as a vehicle engine room have been required to have high thermal creep resistance. Moreover, with growing demand regarding the shape of secondary battery cases, etc., for example, demand for larger or thinner secondary battery cases, etc., such resin compositions have been increasingly required to have high toughness.

Typically, thermal creep resistance and toughness are mutually contradictory properties, and it has been difficult to achieve both thermal creep resistance and toughness at high level.

In addition, demand regarding the appearance of molded products has been on the increase, too.

It could therefore be helpful to provide a resin composition that has an excellent balance between thermal creep resistance and toughness and from which a molded product with favorable appearance can be obtained.

As a result of repeatedly conducting extensive research, we discovered that, by including a predetermined amount of a specific compound in a composition so that the compound is present in each of a polyphenylene ether phase and polypropylene phase at a predetermined concentration, it is possible to realize a resin composition that has an excellent balance between thermal creep resistance and toughness and from which a molded product with favorable appearance can be obtained.

We thus provide the following:

[1] A method of manufacturing a resin composition including 100 parts by mass in total of (A) polypropylene-based resin and (B) polyphenylene ether resin, 1 parts to 20 parts by mass of (C) an admixture, and 0.01 parts to 0.5 parts by mass of (D) one or more compounds selected from the group consisting of a higher fatty acid, a higher fatty acid metal salt, and a higher fatty acid ester, wherein when the resin composition is dissolved in chloroform, a proportion X_{D(B+C)} of the component (D) present in a whole fraction of 100 mass % dissolved in the chloroform is 0.13 mass % to 0.80 mass %, the method comprising:
a first step of melt-kneading the whole component (B), the whole component (C), and 15 mass % to 100 mass % of the component (D) to obtain kneaded material; and
a second step of adding the whole component (A) and the rest of the component (D) (except in the case where the whole component (D) is added in the first step to the kneaded material obtained in the first step, and melt-kneading them,
or the method comprising:
a first step of melt-kneading part of the component (A), the whole component (B), the whole component (C), and 15 mass % to 100 mass % of the component (D) to obtain kneaded material, and
a second step of adding the rest of component (A) and the rest of the component (D) (except in the case where the whole component (D) is added in the first step to the kneaded material obtained in the second step, and melt-kneading them.

[2] The method of manufacturing a resin composition according to [1], wherein the following relationship is satisfied:

6,000≥[{Y_{(D)}−X_{D(B+C)}×(Y_{(B)}+Y_{(C)})/100}/Y_{(A)}]×10⁶≥500

where Y_{(A)}, Y_{(B)}, Y_{(C)}, and Y_{(D)} are respective contents, in parts by mass, of the components (A), (B), (C), and (D) with respect to 100 parts by mass of the components (A) and (B) in total.

[3] The method of manufacturing a resin composition according to [1] or [2], wherein a content of the component (A) is 30 parts to 98 parts by mass with respect to 100 parts by mass of the components (A) and (B) in total.

[4] The method of manufacturing a resin composition according to any one of [1] to [3], wherein the component (D) is the higher fatty acid metal salt.

[5] The method of manufacturing a resin composition according to any one of [1] to [4], wherein the component (C) is one or more selected from the group consisting of a hydrogenated block copolymer, a copolymer having a polystyrene block chain-polyolefin block chain, and a copolymer having a polyphenylene ether block chain-polyolefin block chain.

It is thus possible to provide a resin composition that has an excellent balance between thermal creep resistance and toughness and from which a molded product with favorable appearance can be obtained.

### BRIEF DESCRIPTION OF THE DRAWINGS

In the accompanying drawings:

FIG. 1 is a schematic view (front view) illustrating the shape of a test piece used to evaluate the thermal creep resistance of a resin composition; and

FIG. 2 is a schematic view (plan view) illustrating the shape of a flat plate used to evaluate the molded product appearance of a resin composition.

### DETAILED DESCRIPTION

One of the disclosed embodiments (hereafter referred to as “this embodiment”) is described in detail below. The following embodiment is merely illustrative of the disclosed technique, and the disclosure is not limited to such. Modifications may be made as appropriate within the scope of the disclosure.

[Resin Composition]

A resin composition in this embodiment includes: 100 parts by mass in total of (A) polypropylene-based resin and (B) polyphenylene ether resin; 1 parts to 20 parts by mass of (C) an admixture; and 0.01 parts to 0.5 parts by mass of (D) one or more compounds selected from the group consisting of a higher fatty acid, a higher fatty acid metal salt, and a higher fatty acid ester, wherein when the resin composition is dissolved in chloroform, a proportion X_{D(B+C)} of the component (D) present in a whole fraction of 100 mass % dissolved in the chloroform is 0.13 mass % to 0.80 mass %.

(A) Polypropylene-Based Resin

The resin composition in this embodiment preferably contains at least (A) polypropylene-based resin.

The component (A) is, for example, a propylene homopolymer, a copolymer of propylene and another monomer, or a modified product thereof. The component (A) is preferably crystalline, and more preferably a crystalline propylene homopolymer or a crystalline propylene-ethylene block copolymer. The component (A) may be a mixture of a crystalline propylene homopolymer and a crystalline propylene-ethylene block copolymer.

These examples of the component (A) may be used singly or in combination of two or more.

Examples of another monomer copolymerizable with propylene include α-olefins such as butene-1 and hexene-1. The polymerization form is not particularly limited, and may be a random copolymer, a block copolymer, or the like.

The method of manufacturing the crystalline propylene-ethylene block copolymer is, for example, as follows: A crystalline propylene homopolymer part is synthesized in a first step of polymerization, and the crystalline propylene homopolymer part is copolymerized with propylene, ethylene, and other α-olefin which is used according to need in a second or subsequent step of polymerization.

The method of manufacturing the component (A) is not particularly limited, and may be a well-known method such as a method of polymerizing propylene with or without another monomer in the presence of a catalyst. For example, a method of polymerizing propylene with or without another monomer at a polymerization temperature of 0° C. to 100° C. and a polymerization pressure of 3 atm to 100 atm in the presence of the catalyst and an alkylaluminum compound may be used.

The catalyst used in the manufacture of the component (A) is, for example, a titanium trichloride catalyst, or a halogenated titanium catalyst supported on a carrier such as magnesium chloride. In the manufacture of the component (A), a chain transfer agent such as hydrogen may be added to adjust the molecular weight of the polymer.

The polymerization mode in the manufacture of the component (A) may be any of batch mode and continuous mode. The polymerization method may be selected from solution polymerization in a solvent such as butane, pentane, hexane, heptane, or octane, slurry polymerization, bulk polymerization in a monomer in the absence of a solvent, vapor phase polymerization in a gaseous monomer, etc.

In the manufacture of the component (A), as a third component other than the catalyst, an electron-donating compound may be used as an internal donor component or an external donor component, to enhance the isotacticity or polymerization activity of polypropylene. The electron-donating compound may be a well-known compound. Examples include: ester compounds such as ε-caprolactone, methyl methacrylate, ethyl benzoate, methyl toluate, aromatic monocarboxylic acid ester, and alkoxy ester; phosphite esters such as triphenyl phosphite and tributyl phosphite; phosphoric acid derivatives such as hexamethylphosphoric triamide; alkoxysilanes such as aromatic alkyl alkoxysilane and aliphatic hydrocarbon alkoxysilane; ethers; alcohols; and phenols.

The component (A) may be obtained by modifying native polypropylene-based resin using a modifier such as α,β-unsaturated carboxylic acid or a derivative thereof (including acid anhydride and ester). The modified polypropylene-based resin is obtained, for example, by grafting or adding α,β-unsaturated carboxylic acid or a derivative thereof to native polypropylene-based resin.

As a specific example, α,β-unsaturated carboxylic acid or a derivative thereof is grafted or added to polypropylene-based resin in the proportion of about 0.01 mass % to 10 mass % to the whole polypropylene-based resin. The modified polypropylene-based resin is obtained, for example, by causing the aforementioned native polypropylene-based resin and modifier to react in the range of 30° C. to 350° C. in a molten state, a solution state, or a slurry state in the presence or absence of a radical precursor. In this embodiment, a mixture of the native polypropylene-based resin and the modified polypropylene-based resin at any ratio may be used.

The melt flow rate (MFR) (230° C., 2.16 kgf load) of the component (A) is preferably 0.01 g/10 min to 300 g/10 min, more preferably 0.1 g/10 min to 100 g/10 min, and further preferably 0.1 g/10 min to 30 g/10 min. When the MFR is in the aforementioned range, molding fluidity, stiffness, and thermal creep resistance can be balanced.

Any types of polypropylene-based resin whose MFR is in the aforementioned range may be used singly or in combination of two or more.

The melting point of the component (A) is preferably 163° C. or more, more preferably 165° C. or more, and further preferably 167° C. or more. When the melting point of the component (A) is in the aforementioned numeric range, stiffness and thermal creep resistance after heat history (for example, after heat history of 80° C. for 24 hours) can be further improved.

The melting point of the component (A) can be measured under the conditions of a heating rate of 20° C./min and a cooling rate of 20° C./min using a differential scanning calorimeter (DSC) (“DSC-2 model” made by PerkinElmer Co., Ltd.). In detail, after holding a sample of about 5 mg at 20° C. for 2 minutes, the sample is heated to 230° C. at a heating rate of 20° C./min, and held at 230° C. for 2 minutes. The sample is then cooled to 20° C. at a cooling rate of 20° C./min, and held at 20° C. for 2 minutes. The top peak temperature of an endothermic peak that appears when heating the sample at a heating rate of 20° C./min in this case can be determined as the melting point.

(B) Polyphenylene Ether Resin

The resin composition in this embodiment preferably contains at least (B) polyphenylene ether (PPE) resin.

The component (B) is preferably, but is not limited to, a homopolymer and/or copolymer having a repeating unit structure expressed by the following general formula (1), or a modified product thereof.

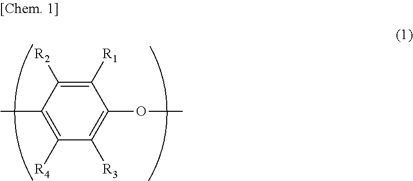

(In the general formula (1), R₁, R₂, R₃, and R₄ each independently represent a hydrogen atom, a halogen atom, a 1 to 7-carbon primary or secondary alkyl group, a phenyl group, a haloalkyl group, an aminoalkyl group, a hydrocarbon oxy group, or a halogenated hydrocarbon oxy group in which at least two carbon atoms separate a halogen atom and an oxygen atom.)

The reduced viscosity (a chloroform solution of 0.5 g/dL, measured at 30° C.) of the component (B) is not particularly limited, but is preferably 0.15 g/dL to 0.7 g/dL and more preferably 0.2 g/dL to 0.6 g/dL.

When the reduced viscosity of the component (B) is in the aforementioned range, the resin composition in this embodiment has excellent impact resistance and heat resistance. The reduced viscosity of the component (B) can be adjusted depending on the production conditions such as the catalyst quantity and polymerization time in polymerization.

The component (B) may be a mixture of two or more types of polyphenylene ether resin that differ in reduced viscosity.

The component (B) is not particularly limited, and may be a well-known component. Examples include: homopolymers such as poly(2,6-dimethyl-1,4-phenylene ether), poly(2-methyl-6-ethyl-1,4-phenylene ether), poly(2-methyl-6-phenyl-1,4-phenylene ether), and poly(2,6-dichloro-1,4-phenylene ether); and copolymers of 2,6-dimethylphenol and other phenols (such as 2,3,6-trimethylphenol and 2-methyl-6-butylphenol), etc. Of these, poly(2,6-dimethyl-1,4-phenylene ether) and a copolymer of 2,6-dimethylphenol and 2,3,6-trimethylphenol are preferable, and poly(2,6-dimethyl-1,4-phenylene ether) is more preferable.

These examples of the component (B) may be used singly or in combination of two or more.

The method of manufacturing the component (B) is not particularly limited, and may be a conventionally well-known method. Examples include the method of oxidative-polymerizing 2,6-xylenol or the like using, as a catalyst, a cuprous salt-amine complex described in U.S. Pat. No. 3,306,874 A and the respective methods described in U.S. Pat. Nos. 3,306,875 A, 3,257,357 A, 3,257,358 A, JP S52-17880 B2, JP S50-51197 A, and JP S63-152628 A.

The component (B) may be obtained by modifying native polyphenylene ether resin using a modifier such as styrene monomer or a derivative thereof. For example, styrene monomer or a derivative thereof is grafted or added to native polyphenylene ether resin. The modified polyphenylene ether resin is obtained, for example, by causing the aforementioned polyphenylene ether resin and styrene monomer or a derivative thereof to react at 80° C. to 350° C. in a molten state, a solution state, or a slurry state in the presence or absence of a radical precursor.

Examples of the modifier for polyphenylene ether resin include styrene monomer, α,β-unsaturated carboxylic acid, and derivatives thereof (e.g. ester compound, acid anhydrous compound, etc.). Examples of the styrene monomer include styrene, α-methylstyrene, and styrenesulfonic acid.

As a specific example of the modified polyphenylene ether resin, styrene monomer or a derivative thereof is grafted or added to polyphenylene ether resin in the proportion of 0.01 mass % to 10 mass %.

The native polyphenylene ether resin and the modified polyphenylene ether resin may be used together as the component (B). The mixing ratio of the native polyphenylene ether resin and the modified polyphenylene ether resin is not particularly limited, and may be any ratio.

In the method of manufacturing the resin composition in this embodiment, one or more selected from the group consisting of polystyrene, syndiotactic polystyrene, and high impact polystyrene may be added to the component (B). Preferably, one or more selected from the group consisting of polystyrene, syndiotactic polystyrene, and high impact polystyrene is added so that their total content does not exceed 400 parts by mass with respect to 100 parts by mass of the polyphenylene ether resin.

(C) Admixture

The resin composition in this embodiment contains at least (C) an admixture. The contained admixture (C) improves the compatibility between the component (A) and the component (B).

By containing the component (C), the resin composition in this embodiment can form a matrix phase including the component (A) and a disperse phase including the component (B). This further improves the thermal creep resistance of the resin composition. The morphology of the resin composition can be identified using, for example, a transmission electron microscope.

The matrix phase is preferably made up of components including at least the component (A). For example, the matrix phase may be made up of components including the components (A) and (D), or made up of components including the components (A), (C), and (D). The disperse phase is preferably made up of components including at least the component (B). For example, the disperse phase may be made up of components including the components (B) and (D), or made up of components including the components (B), (C), and (D). For example, the resin composition in this embodiment may have the matrix phase (e.g. phase including the component (A), phase including the components (A) and (D), phase including the components (A), (C), and (D), or the like) and disperse particles constituting the disperse phase (e.g. phase including the component (B), phase including the components (B) and (D), phase including the components (B), (C), and (D), or the like). The component (C) may be not only contained in the disperse phase, but also partially contained in the matrix phase to such an extent that will not reduce the advantageous effects of this embodiment. When the resin composition in this embodiment takes morphology in which a predetermined concentration of the component (D) is included in the disperse phase including the component (B), the component (B) included in the disperse phase can be in a thermally more stable dispersion state, which is expected to further enhance the advantageous effects of this embodiment (although the functions of this embodiment are not limited to such).

The component (C) is preferably a copolymer having a segment block chain with high compatibility with the component (A) and a segment block chain with high compatibility with the component (B). The term “high compatibility” means any state where phase separation is suppressed.

Examples of the segment block chain with high compatibility with the component (B) include a polystyrene block chain and a polyphenylene ether block chain.

Examples of the segment block chain with high compatibility with the component (A) include a polyolefin block chain and a copolymer elastomer block chain of ethylene and α-olefin.

In this description, it is assumed that the component (C) is not included in the range of the component (A) and the component (B).

The component (C) is, for example, one or more selected from the group consisting of a hydrogenated block copolymer, a copolymer having a polystyrene block chain-polyolefin block chain, and a copolymer having a polyphenylene ether block chain-polyolefin block chain. Of these, the hydrogenated block copolymer is preferable in terms of better thermal stability. These examples of the component (C) may be used singly or in combination of two or more.

The hydrogenated block copolymer is, for example, a hydrogenated block copolymer obtained by hydrogenating at least part of a block copolymer that contains: a polymer block a mainly containing a vinyl aromatic compound; and a polymer block b mainly containing a conjugated diene compound.

A preferable example of the hydrogenated block copolymer is a hydrogenated block copolymer that contains: the polymer block a mainly containing a vinyl aromatic compound; and a polymer block b1 mainly containing a conjugated diene compound whose total sum of 1,2-vinyl bonding amount and 3,4-vinyl bonding amount is 30% to 90%. The total sum of 1,2-vinyl bonding amount and 3,4-vinyl bonding amount of the conjugated diene compound in the polymer block b1 is preferably 30% to 90% in terms of compatibility with polyphenylene ether resin.

The polymer block a is preferably a homopolymer block of a vinyl aromatic compound, or a copolymer block of a vinyl aromatic compound and a conjugated diene compound.

The expression “mainly containing a vinyl aromatic compound” in the polymer block a means that the content of the vinyl aromatic compound unit in the polymer block a is more than 50 mass %. The content of the vinyl aromatic compound unit in the polymer block a is preferably 70 mass % or more, in terms of better molding fluidity, impact resistance, weld, and appearance.

Examples of the vinyl aromatic compound in the polymer block a include styrene, α-methylstyrene, vinyl toluene, p-tert-butylstyrene, and diphenylethylene. Of these, styrene is preferable.

These may be used singly or in combination of two or more.

The number average molecular weight of the polymer block a is not particularly limited, but is preferably 15,000 or more, and preferably 50,000 or less. When the number average molecular weight of the polymer block a is in the aforementioned range, the resin composition in this embodiment has better thermal creep resistance.

The number average molecular weight of the polymer block a can be measured using gel permeation chromatography (GPC) (mobile phase: chloroform, standard substance: polystyrene).

The polymer block b is preferably a homopolymer block of a conjugated diene compound, or a random copolymer block of a conjugated diene compound and a vinyl aromatic compound.

The expression “mainly containing a conjugated diene compound” in the polymer block b means that the content of the conjugated diene compound unit in the polymer block b is more than 50 mass %. The content of the conjugated diene compound unit in the polymer block b is preferably 70 mass % or more, in terms of better molding fluidity, impact resistance, weld, and appearance.

Examples of the conjugated diene compound in the polymer block b include butadiene, isoprene, 1,3-pentadiene, and 2,3-dimethyl-1,3-butadiene. Of these, butadiene, isoprene, and a combination thereof are preferable.

These may be used singly or in combination of two or more.

Regarding the microstructure of the polymer block b (the bonding form of the conjugated diene compound), the total sum (hereafter also referred to as “total vinyl bonding amount”) of 1,2-vinyl bonding amount and 3,4-vinyl bonding amount with respect to the whole vinyl bonding amount in the conjugated diene compound in the polymer block is preferably 30% to 90%, more preferably 45% to 90%, and further preferably 65% to 90%.

When the total vinyl bonding amount of the conjugated diene compound in the polymer block b is in the aforementioned range, the compatibility with the polypropylene-based resin is further improved. In particular, when the total vinyl bonding amount is 30% or more, the component (A) in the resin composition has better dispersibility. When the total vinyl bonding amount is 90% or less, high economic efficiency is attained while maintaining excellent dispersibility of the component (A).

Especially in the case where the polymer block b is a polymer block mainly containing butadiene, the total vinyl bonding amount of butadiene in the polymer block b is preferably 65% to 90%.

The total vinyl bonding amount can be measured using an infrared spectrophotometer. Calculation may be performed according to the method described in Analytical Chemistry, Volume 21, No. 8, August 1949.

The component (C) is preferably a hydrogenated block copolymer of a block copolymer containing at least the polymer block a and the polymer block b.

Let “a” be the polymer block a and “b” be the polymer block b in the component (C). The component (C) is, for example, a hydrogenated vinyl aromatic compound-conjugated diene compound block copolymer having a structure such as a-b, a-b-a, b-a-b-a, (a-b-)₄Si, or a-b-a-b-a. Si in (a-b-)₄Si is a reactive residue of a polyfunctional coupling agent such as silicon tetrachloride or tin tetrachloride, a residue of an initiator such as a polyfunctional organolithium compound, or the like.

The molecular structure of the block copolymer containing the polymer block a and the polymer block b is not particularly limited, and may be straight-chain, branched, radial, or any combination thereof.

The distribution of the vinyl aromatic compound or the conjugated diene compound in the molecular chain in each of the polymer block a and the polymer block b may be random, tapered (the monomer component increases or decreases along the molecular chain), partly in blocks, or any combination thereof.

In the case where any of the polymer block a and the polymer block b is two or more in number in the repeating unit, these two or more polymer blocks may have the same structure or different structures.

Regarding the hydrogenated block copolymer of the component (C), the vinyl aromatic compound-derived constitutional unit contained in the block copolymer before hydrogenation is preferably 20 mass % to 95 mass % and more preferably 30 mass % to 80 mass %, in terms of better molding fluidity, impact resistance, weld, and appearance. The content of the vinyl aromatic compound-derived constitutional unit can be measured using an ultraviolet spectrophotometer.

The number average molecular weight of the block copolymer before hydrogenation is preferably 5,000 to 1,000,000, more preferably 10,000 to 800,000, and further preferably 30,000 to 500,000. The number average molecular weight can be measured using gel permeation chromatography (GPC) (mobile phase: chloroform, standard substance: polystyrene).

The molecular weight distribution of the block copolymer before hydrogenation is preferably 10 or less. The molecular weight distribution can be calculated by finding the ratio (Mw/Mn) of the weight average molecular weight (Mw) to the number average molecular weight (Mn) measured using GPC (mobile phase: chloroform, standard substance: polystyrene).

The hydrogenation ratio of the conjugated diene compound-derived double bond in the component (C) is not particularly limited, but is preferably 50% or more, more preferably 80% or more, and further preferably 90% or more, in terms of better heat resistance. The hydrogenation ratio can be measured using a nuclear magnetic resonance apparatus (NMR).

The method of manufacturing the hydrogenated block copolymer of the component (C) is not particularly limited, and may be a well-known manufacturing method. Examples include the manufacturing methods described in JP S47-011486 A, JP S49-066743 A, JP S50-075651 A, JP S54-126255 A, JP S56-010542 A, JP S56-062847 A, JP S56-100840 A, JP H02-300218 A, GB 1130770 A, U.S. Pat. Nos. 3,281,383 A, 3,639,517 A, GB 1020720 A, U.S. Pat. Nos. 3,333,024 A, and 4,501,857 A.

The hydrogenated block copolymer of the component (C) may be a modified hydrogenated block copolymer obtained by grafting or adding α,β-unsaturated carboxylic acid or a derivative thereof (ester compound or acid anhydrous compound) to the hydrogenated block copolymer.

The modified hydrogenated block copolymer is obtained by causing the aforementioned hydrogenated block copolymer and α,β-unsaturated carboxylic acid or a derivative thereof to react in the range of 80° C. to 350° C. in a molten state, a solution state, or a slurry state in the presence or absence of a radical precursor. In this case, α,β-unsaturated carboxylic acid or a derivative thereof is preferably grafted or added to the hydrogenated block copolymer in the proportion of 0.01 mass % to 10 mass %. Moreover, a mixture of the hydrogenated block copolymer and the modified hydrogenated block copolymer at any ratio may be used.

(D) One or more compounds selected from the group consisting of a higher fatty acid, a higher fatty acid metal salt, and a higher fatty acid ester

The resin composition in this embodiment contains (D) one or more compounds selected from the group consisting of a higher fatty acid, a higher fatty acid metal salt, and a higher fatty acid ester. As the component (D), a higher fatty acid metal salt is preferable in terms of better impact resistance, tensile elongation, and molded product appearance.

The materials as the component (D) may be used singly or in combination of two or more.

The term “higher fatty acid” means aliphatic monocarboxylic acid with 8 or more carbon atoms.

The carbon number of the higher fatty acid is preferably 8 to 40. For example, the higher fatty acid is a saturated or unsaturated, straight-chain or branched aliphatic monocarboxylic acid, although not limited to such. Examples of the higher fatty acid include stearic acid, palmitic acid, behenic acid, erucic acid, oleic acid, lauric acid, and montanoic acid.

These higher fatty acids may be used singly or in combination of two or more.

The higher fatty acid metal salt is a metal salt of the aforementioned higher fatty acid.

Examples of a metal element that forms a salt with the higher fatty acid include group 1 elements (alkali metals), group 2 elements (alkaline earth metals), group 3 elements, zinc, and aluminum in the periodic table. Of these, alkali metals such as sodium and potassium, alkaline earth metals such as calcium and magnesium, and aluminum are preferable.

For example, the higher fatty acid metal salt is metal stearate, metal montanate, metal behenate, metal laurate, or metal palmitate, although not limited to such. Specific examples include calcium stearate, aluminum stearate, zinc stearate, magnesium stearate, calcium montanate, sodium montanate, aluminum montanate, zinc montanate, magnesium montanate, calcium behenate, sodium behenate, zinc behenate, calcium laurate, zinc laurate, and calcium palmitate. As the higher fatty acid metal salt, metal montanate, metal behenate, and metal stearate are suitably used. Of these, calcium stearate, aluminum stearate, zinc stearate, magnesium stearate, calcium montanate, zinc montanate, magnesium montanate, calcium behenate, and zinc behenate are preferable, calcium stearate, aluminum stearate, zinc stearate, and magnesium stearate are more preferable, and calcium stearate, aluminum stearate, and zinc stearate are further preferable.

These higher fatty acid metal salts may be used singly or in combination of two or more.

The higher fatty acid ester is an ester of the higher fatty acid and alcohol.

The higher fatty acid ester is preferably an ester of aliphatic monocarboxylic acid with 8 to 40 carbon atoms and aliphatic alcohol with 8 to 40 carbon atoms. For example, the aliphatic alcohol is stearyl alcohol, behenyl alcohol, or lauryl alcohol, although not limited to such.

Examples of the higher fatty acid ester include stearyl stearate and behenyl behenate.

These higher fatty acid esters may be used singly or in combination of two or more.

Other Materials

The resin composition in this embodiment may contain an inorganic filler according to need.

Examples of the inorganic filler include fibrous, granular, plate-like, or needle-like inorganic reinforcements such as amide ethylenebisstearate, glass fiber, potassium titanate fiber, gypsum fiber, brass fiber, ceramic fiber, boron whisker fiber, mica, talc, silica, calcium carbonate, kaolin, fired kaolin, wollastonite, xonotlite, apatite, glass bead, flaky glass, and titanium oxide, and inorganic fillers surface-treated by well-known methods using surface treatment agents such as silane coupling agents. Here, since natural ore-based fillers tend to contain a slight amount of iron element, it is preferable to select a filler purified to remove the iron element. Of these, glass fiber, carbon fiber, and glass bead are preferable.

These inorganic fillers may be used singly or in combination of two or more.

The content of the inorganic filler is preferably 2 mass % to 60 mass %, more preferably 3 mass % to 50 mass %, and further preferably 5 mass % to 45 mass % with respect to the total content of the resin composition. When the content is in the aforementioned range, it is possible to obtain a molded product that has excellent mechanical strength, has excellent dimensional accuracy with a lower linear expansion coefficient depending on a temperature change (for example, a change from −30° C. to 120° C.), and maintains anisotropy.

The resin composition in this embodiment may contain various additives according to need.

Non-limiting examples of such additives include other thermoplastic resins such as polyamide, polyester, and polyolefin other than the component (A), plasticizers (such as low-molecular-weight polyolefin other than the component (A), polyethylene glycol, and fatty acid ester amides), antistats, nucleating agents, fluidity improving agents, reinforcers, peroxides, spreaders, organic heat stabilizers such as a hindered phenol oxidative degradation inhibitor, antioxidants, ultraviolet absorbers, light stabilizers, flame retardants, and colorants.

The content of the additives is preferably 10 mass % or less, more preferably 5 mass %, and further preferably 3 mass % or less with respect to the total content of the resin composition.

The resin composition in this embodiment includes the components (A) to (D) as basic components.

The total content of the components (A) and (B) in the resin composition in this embodiment is preferably 80 mass % to 99 mass % and more preferably 80 mass % to 98 mass % with respect to the total content of the resin composition.

The content of the component (A) is not particularly limited, but is preferably 30 parts to 98 parts by mass and more preferably 30 parts to 95 parts by mass with respect to 100 parts by mass of the components (A) and (B) in total. When the content of the component (A) is 30 parts by mass or more, better molding processability and thermal creep resistance are attained.

The content of the component (B) is not particularly limited, but is preferably 2 parts to 70 parts by mass and more preferably 5 parts to 70 parts by mass with respect to 100 parts by mass of the components (A) and (B) in total. When the content of the component (B) is 2 parts by mass or more, better heat resistance is attained.

The content of the component (C) is 1 parts to 20 parts by mass and preferably 1 parts to 15 parts by mass with respect to 100 parts by mass of the components (A) and (B) in total. When the content of the component (C) is in the aforementioned range, an excellent balance between thermal creep resistance and impact resistance is achieved.

The content of the component (D) is 0.01 parts to 0.5 parts by mass, preferably 0.03 parts to 0.5 parts by mass, more preferably 0.05 parts to 0.5 parts by mass, and further preferably 0.1 parts to 0.5 parts by mass with respect to 100 parts by mass of the components (A) and (B) in total. When the content of the component (D) is in the aforementioned range, the resin composition has an excellent balance between thermal creep resistance and impact resistance and favorable molded product appearance.

The following describes the properties of the resin composition in this embodiment in detail.

Concentration X_{D(B+C)} of Component (D) Present in Fraction Dissolved in Chloroform

When the resin composition in this embodiment is dissolved in chloroform, the proportion (X_{D(B+C)}) of the component (D) present in the whole fraction (100 mass %) dissolved in chloroform is 0.13 mass % to 0.80 mass %, preferably 0.15 mass % to 0.80 mass %, and more preferably 0.17 mass % to 0.80 mass %. When X_{D(B+C)} is in the aforementioned range, the resin composition has an excellent balance between thermal creep resistance and impact resistance and favorable molded product appearance.

X_{D(B+C)} can be measured by the following method.

After freezing and crushing the resin composition in this embodiment in liquid nitrogen, the resin composition is sieved, and a powder that has passed through 500 μm meshes but has not passed through 355 μm meshes is collected. 20 mL of chloroform is added to about 5 g of the powder, and the mixture is stirred at normal temperature for 1 hour and then filtered through filter paper to collect filtrate. The filtrate is heated to 60° C. and dried, and further dried with a vacuum dryer at 80° C. for 2.5 hours. The weight of the resulting extract is measured. The extract is regarded as the fraction dissolved in chloroform. The concentration of the component (D) extracted in the chloroform-soluble fraction obtained by this operation can be measured using inductively coupled plasma source mass spectrometry (ICP-MS), gas chromatography (GC), or high-performance liquid chromatography (HPLC).

The components included in the fraction dissolved in chloroform when the resin composition in this embodiment is dissolved in chloroform are components mainly constituting the disperse phase. In detail, these components are the component (B), the component (D) contained in the component (B), and part of the component (D) contained in the component (A). Since the component (D) is adequately included in the chloroform-soluble fraction which mainly contains the components constituting the disperse phase, a molded product in which the component (D) is adequately present in the matrix phase and the disperse phase can be obtained. Such a molded product has excellent toughness.

The resin composition in this embodiment preferably satisfies the following relationship:

6,000≥[{Y_{(D)}−X_{D(B+C)}×(Y_{(B)}+Y_{(C)})/100}/Y_{(A)}]×10⁶≥500

where Y_{(A)}, Y_{(B)}, Y_{(C)}, and Y_{(D)} are the respective contents (parts by mass) of the components (A), (B), (C), and (D) with respect to 100 parts by mass of the components (A) and (B) in total.

In particular, the resin composition preferably satisfies 6,000 [{Y_{(D)}−X_{D(B+C)}×(Y_{(B)}+Y_{(C)})/100}/Y_{(A)}]×10⁶≥600.

When the respective contents of the components in the resin composition satisfy the aforementioned relationship, the resin composition has little variation in (nominal) tensile strain at break, and also a molded product with better appearance can be obtained from the resin composition.

In this description, [{Y_{(D)}−X_{D(B+C)}×(Y_{(B)}+Y_{(C)})/100}/Y_{(A)}]×10⁶ is also referred to as “expression M”.

The expression M represents rough concentration (mass ppm) of the component (D) in the component (A) constituting the matrix phase. When the rough concentration of the component (D) in the component (A) calculated from the expression M is 500 or more (preferably 600 or more), metal detachability during melting increases, the material is less likely to stay in a dead space in an extruder or molding machine, and resin that is exposed to high temperature for a long time and thermally deteriorate is reduced. Thus, a molded product with favorable appearance having few dark spots is obtained, while suppressing a decrease in toughness due to contamination. When the rough concentration of the component (D) in the component (A) calculated from the expression M is 6000 or less, molding appearance defects such as silver streaks are reduced.

[Manufacture of Resin Composition]

The method of manufacturing the resin composition in this embodiment is not particularly limited. For example, manufacturing methods using various melt kneaders or kneading extruders are available.

In the method of manufacturing the resin composition in this embodiment, let X_{D(B+C)} be the concentration of the component (D) present in the fraction dissolved in chloroform when the resin composition is dissolved in the chloroform. The following gives examples of the manufacturing method by which X_{D(B+C)} is 0.13 mass % to 0.80 mass %.

Manufacturing Method 1: Manufacturing Method Including (Step 1-1) and (Step 1-2)

(step 1-1): a step of melt-kneading the whole component (B), the whole component (C), and 15 mass % to 100 mass % of the component (D) to obtain kneaded material.

(step 1-2): a step of adding the whole component (A) and the rest of the component (D) (except in the case where the whole component (D) is added in (step 1-1)) to the kneaded material obtained in (step 1-1), and melt-kneading them.

Manufacturing Method 2: Manufacturing Method Including (Step 2-1) and (Step 2-2)

(step 2-1): a step of melt-kneading part of the component (A), the whole component (B), the whole component (C), and 15 mass % to 100 mass % of the component (D) to obtain kneaded material.

(step 2-2): a step of adding the rest of component (A) and the rest of the component (D) (except in the case where the whole component (D) is added in (step 2-1)) to the kneaded material obtained in (step 2-1), and melt-kneading them.

In each of these manufacturing methods, the addition amount of the component (D) in (step 1-1) or (step 2-1) is preferably 15 mass % or more, more preferably 30 mass % or more, and further preferably 50 mass % or more. When the addition amount of the component (D) is in the aforementioned range, the value of the expression M is likely to be in the range of 500 to 6,000, and the resin composition not only has an excellent balance between thermal creep resistance and impact resistance but also has little variation in (nominal) tensile strain at break.

In (step 1-1) in the manufacturing method 1, when the addition amount of the component (D) is 15 mass % or more, the resin composition has excellent molded product appearance.

In the manufacturing method 2, the component (A) is added in parts in (step 2-1) and (step 2-2). Here, the addition amount of the component (A) in (step 2-1) is preferably 5 mass % to 50 mass %, and more preferably 10 mass % to 50 mass %. When the addition amount of the component (A) is in the aforementioned range, the resin composition has a particularly excellent balance between thermal creep resistance and impact resistance.

The addition amount of the component (A) in (step 2-2) is preferably 50 mass % to 95 mass %, and more preferably 50 mass % to 90 mass %.

The melt kneader or kneading extruder is not particularly limited, and a well-known kneader may be used. Examples include single screw extruders, multi-screw extruders such as twin screw extruders, rolls, kneaders, Brabender Plastograph, and heat melt kneaders such as Banbury mixers. Of these, twin screw extruders are preferable. Specific examples include kneading extruders such as “ZSK” series made by Coperion K.K., “TEM” series made by Toshiba Machine Co., Ltd., and “TEX” series made by Japan Steel Works, Ltd.

In the case of using an extruder, the type, specifications, etc. of the extruder are not particularly limited, and a well-known extruder may be used as appropriate. The L/D ratio (barrel effective length (L)/barrel internal diameter (D)) of the extruder is preferably 20 to 75, and more preferably 30 to 60.

For example, in a preferable extruder, a first raw material supply port is provided upstream in the raw material flow direction, a first vacuum vent is provided downstream from the first raw material supply port, a second raw material supply port is provided downstream from the first vacuum vent, and a second vacuum vent is provided downstream from the second raw material supply port. The extruder may further include a third raw material supply port, a third vacuum vent, etc. downstream from these components. The total number and arrangement of raw material supply ports in the extruder may be set as appropriate based on the number of types of materials in the resin composition and the like.

The method of supplying raw material o the second raw material supply port is not particularly limited. However, rather than simply supplying raw material from the opening of the second or third raw material supply port, it is more preferable to supply raw material from an extruder-side opening using a forced side feeder, for higher stability.

The melt kneading temperature and the screw speed are not particularly limited. Typically, however, a melt kneading temperature of 200° C. to 370° C. and a screw speed of 100 rpm to 1200 rpm are preferable.

[Molded Product]

A molded product of the resin composition in this embodiment can be manufactured by a well-known molding method. The molding method is not particularly limited. Examples include injection molding, extrusion molding, press molding, blow molding, calendar molding, and casting.

In detail, the following methods are available: a method of melting the resin composition in a cylinder of an injection molding machine whose cylinder temperature is adjusted in the range of the melting point of the component (A) to 330° C. and injecting the resin composition into a die of a predetermined shape, to manufacture a molded product having the predetermined shape; a method of melting the resin composition in an extruder whose cylinder temperature is adjusted in the aforementioned range and spinning the resin composition from a spinning nozzle, to manufacture a fibrous molded product; and a method of melting the resin composition in an extruder whose cylinder temperature is adjusted in the aforementioned range and extruding the resin composition from a T die, to manufacture a film-like or sheet-like molded product.

The molded product manufactured by the aforementioned method may have a coating layer made of paint, metal, another type of polymer, or the like on its surface.

The molded product obtained from the resin composition in this embodiment has an excellent balance between thermal creep resistance and toughness and favorable appearance. Such a molded product can be used in automobile components, electrical and electronic equipment components, and home appliances, and is particularly suitable for automobile exterior components or exterior panel components, automobile interior components, automobile under-hood components, secondary battery cases, and printer ink peripheral components. The molded product obtained from the resin composition in this embodiment excellent in chemical resistance, molding processability, heat resistance, dimensional stability, low water absorbability, and electrical property is particularly suitable for these applications.

### EXAMPLE

Specific examples and comparative examples are described below with regard to the disclosure, although the disclosure is not limited to such.

The following measurement methods and raw materials were used in the examples and comparative examples.

(Method of Measuring Each Property)

(1) Melt Volume Flow Rate

Using a resin composition pellet manufactured in each of the below-mentioned examples and comparative examples, the melt volume flow rate (cm³/10 min) was measured at 250° C. with a load of 10 kgf according to ISO 1133. A higher measurement value indicates better heat resistance.

(2) Notched Charpy Impact Strength

Using a resin composition pellet manufactured in each of the below-mentioned examples and comparative examples, a JIS K 7139 A multi-purpose specimen was formed at a cylinder temperature of 240° C. to 280° C. and a die temperature of 60° C. by an injection molding machine (IS-80EPN made by Toshiba Machine Co., Ltd.). The multi-purpose specimen was left in an environment of 80° C. for 24 hours using a gear oven, to perform heat history treatment. A specimen was further cut out of the multi-purpose specimen after the heat history treatment, and its Charpy impact strength was evaluated under the temperature condition of 23° C. according to ISO 179.

Five specimens were formed, the measurement was performed once for each specimen, and the average value was set as notched Charpy impact strength (kJ/m²). A higher value indicates better impact resistance.

(3) Tensile Test

Using a resin composition pellet manufactured in each of the below-mentioned examples and comparative examples, a JIS K 7139 A multi-purpose specimen was formed at a cylinder temperature of 240° C. to 280° C. and a die temperature of 60° C. by an injection molding machine (IS-80EPN made by Toshiba Machine Co., Ltd.). The multi-purpose specimen was left in an environment of 80° C. for 24 hours using a gear oven, to perform heat history treatment. Using the multi-purpose specimen after the heat history treatment as a tensile test specimen, a tensile test was performed according to ISO 527, and tensile strength (MPa) and (nominal) tensile strain at break (%) were measured.

15 specimens were formed, the measurement was performed once for each specimen, and the average values were set as tensile strength (MPa) and (nominal) tensile strain at break (%). A higher value indicates better tensile strength or tensile strain at break.

Moreover, the standard deviation of the 15 measurement values of (nominal) tensile strain at break was set as variation in (nominal) tensile strain at break. A lower value indicates less variation.

(4) Thermal Creep Resistance

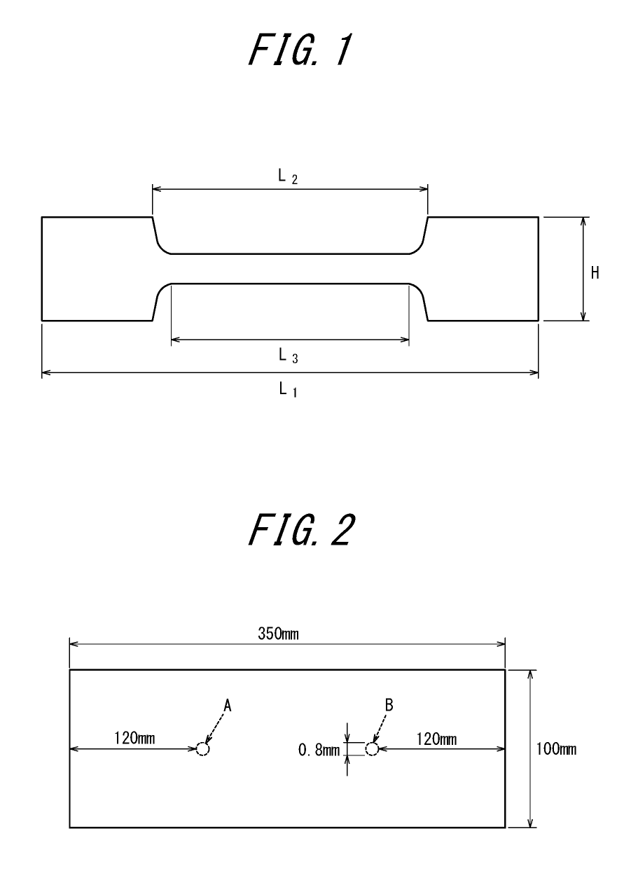

Using a resin composition pellet manufactured in each of the below-mentioned examples and comparative examples, a creep measurement test piece was formed at a cylinder temperature of 245° C. and a die temperature of 60° C. by an injection molding machine (TI50G2 made by Toyo Machinery & Metal Co., Ltd.). The creep measurement test piece was left in an environment of 80° C. for 24 hours using a gear oven, to perform heat history treatment. As the creep measurement test piece, a dumbbell molded product (1 mm in thickness) illustrated in FIG. 1 was used. FIG. 1 is a simplified front view of a test piece used in the examples. A creep measurement test piece had a width L₁ of 65 mm, a width L₂ of 40 mm, a width L₃ of 22 mm, and a height H of 10 mm.

Creep measurement was performed using the creep measurement test piece after the heat history treatment. The creep measurement (thermal creep resistance test) was conducted under the conditions of an inter-chuck distance of 40 mm, a test load equivalent to stress of 12.25 MPa, a test temperature of 80° C., and a test time of 165 hours, using a creep tester (“145-B-PC model” made by Yasuda Seiki Seisakusho, Ltd.). Strain (%) calculated from the following expression was set as thermal creep resistance. A lower thermal creep resistance value indicates better thermal creep resistance.

Strain (%)=(deviation of inter-chuck distance of test piece after 165 hours)/(inter-chuck distance)×100.

(5) Molded Product Appearance (Die Temperature of 60° C.)

A flat plate illustrated in FIG. 2 was manufactured at a cylinder temperature of 280° C. and a die temperature of 60° C. by an injection molding machine (SE-130B made by Sumitomo Heavy Industries, Ltd.).

The size of the flat plate was 350 mm×100 mm (2 mm in thickness). In FIG. 2, regions A and B are portions connected to gates during injection molding, with each gate diameter being 0.8 mmϕ. Whether or not silver streaks occurred around the gates and in the weld portion of the flat plate was visually observed. The molded product appearance was rated as good in the case where no silver streaks were found, and poor in the case where silver streaks were found.

(6) X_{D(B+C)}

After freezing and crushing the resin composition obtained in each of the examples and comparative examples in liquid nitrogen, the resin composition was sieved, and a powder that had passed through 500 μm meshes but had not passed through 355 μm meshes was collected. 20 mL of chloroform was added to about 5 g of the powder, and the mixture was stirred at normal temperature for 1 hour and then filtered through filter paper to collect filtrate. The filtrate was heated to 60° C. and dried, and further dried with a vacuum dryer at 80° C. for 2.5 hours. The weight (g) of the resulting extract was measured. The extract was regarded as the fraction dissolved in chloroform.

The calcium content of the obtained extract was determined using ICP-atomic emission spectrometry in the case of component (d-1), GC analysis in the case of component (d-2), and high-performance liquid chromatography (HPLC) in the case of component (d-3), to measure the content (g) of the component (D). From the obtained content of the component (D) and mass of the extract, the concentration (mass %) of the component (D) in the fraction dissolved in chloroform was calculated.

### Raw Materials Used in Examples and Comparative Examples

[(A) Polypropylene-Based Resin]

(a-1): Polypropylene resin with a number average molecular weight of 120,000, a weight average molecular weight of 1,280,000, a molecular weight distribution (Mw/Mn) of 10.7, a melting point of 168° C., a density of 0.90 g/cm³, and MFR of 0.4 g/10 min (230° C., 2.16 kgf).

(a-2): Polypropylene resin with a number average molecular weight of 120,000, a weight average molecular weight of 1,280,000, a molecular weight distribution (Mw/Mn) of 10.7, a melting point of 166° C., a density of 0.90 g/cm³, MFR of 0.4 g/10 min (230° C., 2.16 kgf), and calcium stearate content of 0.05 wt %.

The molecular weight and the molecular weight distribution were measured using a gel permeation chromatograph (hereafter, GPC).

<Gpc Conditions>

Measurement device: gel permeation chromatograph Alliance GPC 2000 model (made by Waters Corporation)

Column: TSKgel GMH6-HT (made by Tosoh Corporation)×2+TSKgel GMH6-HTL (made by Tosoh Corporation)×2 connected in series

Flow rate: 1.0 mL/min

Detector: refractive index detector (RI)

Solvent: o-dichlorobenzene

Column temperature: 140° C.

Sample concentration: 0.15%

Injection amount: 0.5 mL

Molecular weight calibration: polystyrene conversion

[(B) Polyphenylene Ether Resin]

(b-1): PPE was prepared as follows, in the same way as Example 1 in WO 2011/105504 A1.

160.8 g of cupric oxide, 1209.0 g of a 47% hydrogen bromide aqueous solution, 387.36 g of di-t-butylethylenediamine, 1875.2 g of di-n-butylamine, 5707.2 g of butyldimethylamine, 826 kg of toluene, and 124.8 kg of 2,6-dimethylphenol were charged in a stainless steel-made, 2000-L, jacket-equipped polymerization tank equipped on the bottom of the polymerization tank with an iron-made sparger to introduce an oxygen-containing gas, a stainless steel-made stirring turbine blade and a stainless steel-made baffle, and on a vent gas line on the upper part of the polymerization tank with a reflux cooler, while a nitrogen gas was being blown in at a flow volume of 13 NL/min, and stirred until the mixture became a homogeneous solution and the internal temperature of the reactor became 25° C.

Then, dried air started to be introduced at a rate of 1312 NL/min from the sparger into the polymerization tank, and the polymerization was initiated. The aeration was carried out for 142 minutes, and the internal temperature at the end of the polymerization was controlled to be 40° C. The polymerization liquid at the end of the polymerization was in a solution state.

The aeration of the dried air was stopped; 100 kg of a 2.5 mass % aqueous solution of an ethylenediaminetetraacetic acid tetrasodium salt (a reagent made by Dojindo Laboratories) was added to the polymerization mixture, and the polymerization mixture was stirred at 70° C. for 150 minutes, and then allowed to stand; and the resultant was subjected to liquid-liquid separation (a disc-type centrifugal separating machine made by GEA Group AG) to be separated into an organic phase and a water phase.

The temperature of the obtained organic phase was set to room temperature, and methanol was excessively added to manufacture a slurry in which a polyphenylene ether was precipitated. After this, the slurry was filtered using a basket centrifuge (0-15 model made by Tanabe Willtec Inc.).

After the filtration, methanol was excessively charged in the basket centrifuge, and again filtered to obtain a wet polyphenylene ether. The wet polyphenylene ether was then charged and crushed in a feather mill (FM-1S made by Hosokawa Micron Corp.) equipped with 10 mm round-hole meshes, and held at 150° C. at 1 mmHg for 1.5 hours using a conical drier to obtain a dry-state PPE powder. The reduced viscosity of the PPE was 0.52 dL/g (0.5 g/dL, chloroform solution, measured at 30° C.).

[(C) Admixture]

(c-1): Hydrogenated block copolymer having a structure of polystyrene-hydrogenated polybutadiene-polystyrene. The content of the styrene unit in the block copolymer before hydrogenation was 43%, the 1,2-vinyl bonding amount of the polybutadiene part was 75%, the number average molecular weight of the polystyrene chain was 20,000, and the hydrogenation ratio of the polybutadiene part was 99.9%.

The hydrogenated block copolymer was obtained as follows. Using n-butyllithium as an initiator and tetrahydrofuran as a regulator of the 1,2-vinyl bonding amount, styrene and butadiene were anionic block copolymerized in a cyclohexane solvent to obtain a styrene-butadiene block copolymer. Following this, using bis(η5-cyclopentadienyl)titaniumdichloride and n-butyllithium as hydrogenation catalysts, the obtained styrene-butadiene block copolymer was hydrogenated under the conditions of a hydrogen pressure of 5 kg/cm² and a temperature of 50° C. The polymer structure was controlled by adjusting the charge quantity and charge sequence of the monomers. The molecular weight was controlled by adjusting the catalyst quantity. The 1,2-vinyl bonding amount was controlled by adjusting the addition amount of the regulator of the 1,2-vinyl bonding amount and the polymerization temperature. The hydrogenation ratio was controlled by adjusting the hydrogenation time.

The 1,2-vinyl bonding amount of the polybutadiene part was measured using an infrared spectrophotometer, and calculated according to the method described in Analytical Chemistry, Volume 21, No. 8, August 1949. The bonded styrene amount was measured using an ultraviolet spectrophotometer.

The number average molecular weight of the polystyrene chain was measured using GPC (mobile phase: chloroform, standard substance: polystyrene). The hydrogenation ratio of the polybutadiene part was measured using a NMR.

[(D) One or More Compounds Selected from the Group Consisting of a Higher Fatty Acid, a Higher Fatty Acid Metal Salt, and a Higher Fatty Acid Ester]

(d-1): Calcium stearate, melting point: 155° C., metal content: 6.7 mass %.

(d-2): Stearic acid, melting point: 69° C., neutralization number: 196.

(d-3): Stearyl stearate, melting point: 55° C.

[Other Materials]

Amide ethylenebisstearate, melting point: 143° C.

### Examples 1 to 10 and Comparative Examples 1 to 8

A twin screw extruder (TEM58SS made by Toshiba Machine Co., Ltd., L/D=53.8) having three supply ports on the upstream and downstream sides was used. Assuming the total length of the extruder cylinder to be 1.0, a supply port at the position of L=0 from the upstream end was a first raw material supply port (upstream supply port), and a supply port at the position of L=0.4 from the upstream end was a second raw material supply port (downstream supply port). Melt kneading was performed under the conditions of an extruder barrel setting temperature of 270° C. to 320° C., a screw speed of 450 rpm, and a discharge rate of 400 kg/hour, to obtain a resin composition pellet. The aforementioned evaluations were conducted using the obtained resin composition pellet. The detailed manufacturing methods and evaluation results are shown in Table 1 below.

TABLE 1

| | | | | | Ex. | Ex. | Ex. | Ex. | Ex. | Ex. | Ex. |
|---|---|---|---|---|---|---|---|---|---|---|---|
| | | | | | 1 | 2 | 3 | 4 | 5 | 6 | 7 |
| Manufacture | First raw | Component (A) | a-1 | parts | 30 | — | 30 | 30 | 30 | 30 | 30 |
| of resin | material | | a-2 | by mass | — | 30 | — | — | — | — | — |
| composition | supply port | Component (B) | b-1 | parts | 10 | 10 | 10 | 10 | 10 | 10 | 10 |
| | | | | by mass | | | | | | | |
| | | Component (C) | c-1 | parts | 3 | 3 | 3 | 3 | 3 | 3 | 3 |
| | | | | by mass | | | | | | | |
| | | Component (D) | d-1 | parts | 0.1 | 0.085 | — | — | 0.05 | 0.3 | 0.5 |
| | | | d-2 | by mass | — | — | 0.1 | — | — | — | — |
| | | | d-3 | | — | — | — | 0.1 | — | — | — |
| | | Other materials | | parts | — | — | — | — | — | — | — |
| | | | | by mass | | | | | | | |
| | Second raw | Component (A) | a-1 | parts | 60 | 60 | 60 | 60 | 60 | 60 | 60 |
| | material | | a-2 | by mass | — | — | — | — | — | — | — |
| | supply port | Component (D) | d-1 | parts | — | — | — | — | — | — | — |
| | | | | by mass | | | | | | | |

| Resin | Content | Component (A) | parts | 90 | 90 | 90 | 90 | 90 | 90 | 90 |
|---|---|---|---|---|---|---|---|---|---|---|
| composition | of each | | by mass | | | | | | | |
| | component | Component (B) | parts | 10 | 10 | 10 | 10 | 10 | 10 | 10 |
| | | | by mass | | | | | | | |
| | | Component (C) | parts | 3 | 3 | 3 | 3 | 3 | 3 | 3 |
| | | | by mass | | | | | | | |
| | | Component (D) | parts | 0.1 | 0.1 | 0.1 | 0.1 | 0.05 | 0.3 | 0.5 |
| | | | by mass | | | | | | | |
| | Physical | X_{D(B+C)} | mass % | 0.20 | 0.20 | 0.18 | 0.20 | 0.15 | 0.38 | 0.46 |
| | property | [{Y_{(D)} − X_{D(B+C)} × | — | 826 | 826 | 848 | 826 | 336 | 2785 | 4898 |
| | | (Y_{(B)} + Y_{(C)})/100}/ | | | | | | | | |
| | | Y_{(A)}] × 10⁶ | | | | | | | | |
| Evaluation | (1) Melt volume flow rate | | cm³/10 min | 15 | 15 | 15 | 15 | 15 | 19 | 20 |
| | (2) Charpy impact strength | | kJ/m² | 24 | 24 | 20 | 21 | 22 | 25 | 29 |
| | (3) Tensile test | Tensile strength | MPa | 37 | 37 | 37 | 37 | 37 | 37 | 37 |
| | | (Nominal) tensile strain | % | 53 | 53 | 50 | 54 | 50 | 65 | 67 |
| | | at break | | | | | | | | |
| | | Variation in (nominal) | — | 3.1 | 3.1 | 3.3 | 3.4 | 3.8 | 3.0 | 3.0 |
| | | tensile strain at break | | | | | | | | |

| | | | | | | | | |
|---|---|---|---|---|---|---|---|---|
| (4) Thermal creep resistance | % | 9 | 9 | 10 | 10 | 9 | 9 | 11 |
| (5) Molded product appearance | — | Good | Good | Good | Good | Good | Good | Good |

| | | | | | Ex. | Ex. | Ex. | Com. | Com. | Com. |
|---|---|---|---|---|---|---|---|---|---|---|
| | | | | | 8 | 9 | 10 | Ex. 1 | Ex. 2 | Ex. 3 |
| Manufacture | First raw | Component (A) | a-1 | parts | — | 30 | 30 | 30 | 20 | — |
| of resin | material | | a-2 | by mass | 30 | — | — | — | 10 | 30 |
| composition | supply port | Component (B) | b-1 | parts | 10 | 10 | 10 | 10 | 10 | 10 |
| | | | | by mass | | | | | | |
| | | Component (C) | c-1 | parts | 3 | 3 | 3 | 3 | 3 | 3 |
| | | | | by mass | | | | | | |
| | | Component (D) | d-1 | parts | 0.5 | 0.05 | 0.15 | — | — | — |
| | | | d-2 | by mass | — | — | — | — | — | — |
| | | | d-3 | | — | — | — | — | — | — |
| | | Other materials | | parts | — | — | — | — | — | — |
| | | | | by mass | | | | | | |
| | Second raw | Component (A) | a-1 | parts | 60 | 60 | 60 | 60 | 60 | — |
| | material | | a-2 | by mass | — | — | — | — | — | 60 |
| | supply port | Component (D) | d-1 | parts | 0.2 | 0.25 | 0.15 | — | — | — |
| | | | | by mass | | | | | | |

| Resin | Content | Component (A) | parts | 90 | 90 | 90 | 90 | 90 | 90 |
|---|---|---|---|---|---|---|---|---|---|
| composition | of each | | by mass | | | | | | |
| | component | Component (B) | parts | 10 | 10 | 10 | 10 | 10 | 10 |
| | | | by mass | | | | | | |
| | | Component (C) | parts | 3 | 3 | 3 | 3 | 3 | 3 |
| | | | by mass | | | | | | |
| | | Component (D) | parts | 0.715 | 0.3 | 0.3 | 0 | 0.005 | 0.045 |
| | | | by mass | | | | | | |
| | Physical | X_{D(B+C)} | mass % | 0.73 | 0.26 | 0.30 | <0.01 | <0.01 | 0.10 |
| | property | [{Y_{(D)} − X_{D(B+C)} × | — | 6890 | 2961 | 2895 | — | — | 356 |
| | | (Y_{(B)} + Y_{(C)})/100}/ | | | | | | | |
| | | Y_{(A)}] × 10⁶ | | | | | | | |
| Evaluation | (1) Melt volume flow rate | | cm³/10 min | 21 | 18 | 18 | 14 | 15 | 16 |
| | (2) Charpy impact strength | | kJ/m² | 29 | 23 | 24 | 19 | 19 | 19 |
| | (3) Tensile test | Tensile strength | MPa | 37 | 37 | 37 | 36 | 37 | 37 |
| | | (Nominal) tensile strain | % | 67 | 55 | 55 | 40 | 41 | 40 |
| | | at break | | | | | | | |
| | | Variation in (nominal) | — | 3.0 | 2.9 | 3.0 | 4.7 | 4.8 | 3.9 |
| | | tensile strain at break | | | | | | | |

| | | | | | | | |
|---|---|---|---|---|---|---|---|
| (4) Thermal creep resistance | % | 10 | 9 | 10 | 9 | 9 | 10 |
| (5) Molded product appearance | — | Good | Good | Good | Good | Good | Good |

| | | | | | Com. | Com. | Com. | Com. | Com. |
|---|---|---|---|---|---|---|---|---|---|
| | | | | | Ex 4 | Ex 5 | Ex 6 | Ex 7 | Ex 8 |
| Manufacture | First raw | Component (A) | a-1 | parts | 30 | 30 | 30 | 20 | 30 |
| of resin | material | | a-2 | by mass | — | — | — | 10 | — |
| composition | supply port | Component (B) | b-1 | parts | 10 | 10 | 10 | 10 | 10 |
| | | | | by mass | | | | | |
| | | Component (C) | c-1 | parts | 3 | 3 | 3 | 3 | 3 |
| | | | | by mass | | | | | |
| | | Component (D) | d-1 | parts | — | — | — | — | — |
| | | | d-2 | by mass | — | — | — | — | — |
| | | | d-3 | | 0.6 | 0.8 | — | — | — |

| | Other materials | | parts | — | — | — | — | 0.1 |
|---|---|---|---|---|---|---|---|---|
| | | | by mass | | | | | |
| Second raw | Component | a-1 | parts | 60 | 60 | 60 | 60 | 60 |
| material | (A) | a-2 | by mass | — | — | — | — | — |
| supply port | Component (D) | d-1 | parts | — | — | 0.05 | 0.045 | — |
| | | | by mass | | | | | |

| | | | | | | | | |
|---|---|---|---|---|---|---|---|---|
| Resin | Content | Component (A) | parts | 90 | 90 | 90 | 90 | 90 |
| composition | of each | | by mass | | | | | |
| | component | Component (B) | parts | 10 | 10 | 10 | 10 | 10 |
| | | | by mass | | | | | |
| | | Component (C) | parts | 3 | 3 | 3 | 3 | 3 |
| | | | by mass | | | | | |
| | | Component (D) | parts | 0.6 | 0.8 | 0.05 | 0.05 | 0 |
| | | | by mass | | | | | |
| | Physical | X_{D(B+C)} | mass % | 0.82 | 0.99 | 0.11 | 0.08 | — |
| | property | [{Y_{(D)} − X_{D(B+C)} × | — | 5482 | 7464 | 402 | 446 | — |
| | | (Y_{(B)} + Y_{(C)})/100}/ | | | | | | |
| | | Y_{(A)}] × 10⁶ | | | | | | |

| | | | | | | | |
|---|---|---|---|---|---|---|---|
| Evaluation | (1) Melt volume flow rate | cm³/10 min | 21 | 21 | 15 | 15 | 16 |
| | (2) Charpy impact strength | kJ/m² | 29 | 29 | 19 | 19 | 19 |

| | | | | | | | |
|---|---|---|---|---|---|---|---|
| (3) Tensile test | Tensile strength | MPa | 37 | 37 | 37 | 37 | 37 |
| | (Nominal) tensile strain | % | 67 | 68 | 41 | 43 | 40 |
| | at break | | | | | | |
| | Variation in (nominal) | — | 3 | 3.1 | 3.8 | 3.0 | 4.4 |
| | tensile strain at break | | | | | | |

| | | | | | | |
|---|---|---|---|---|---|---|
| (4) Thermal creep resistance | % | 10 | 9 | 10 | 9 | 10 |
| (5) Molded product appearance | — | Poor | Poor | Good | Good | Good |

Examples (Ex.) 1 to 10 had an excellent balance between molding fluidity, impact resistance, tensile elongation, and thermal creep resistance, little variation in tensile elongation, and favorable molded product appearance.

In Comparative Example (Com. Ex.) 1, the addition amount of the component (D) was less than the range according to the disclosure, and so impact strength and tensile elongation were poor.

In Comparative Examples 2, 3, 6, and 7, the addition amount of the component (D) was within the range according to the disclosure but the value of X_{D(B+C)} was less than the range according to the disclosure, and so impact strength and tensile elongation were poor.

In Comparative Examples 4 and 5, the addition amount of the component (D) was more than the range according to the disclosure, and so molded product appearance was poor.

In Comparative Example 8, another material was used instead of the component (D), and so impact strength and tensile elongation were poor.

### INDUSTRIAL APPLICABILITY

The resin composition according to the disclosure has industrial applicability as automobile components, electrical and electronic equipment components, and home appliances, and particularly as automobile exterior components or exterior panel components, automobile interior components, automobile under-hood components, secondary battery cases, and printer ink peripheral components.

1. A method of manufacturing a resin composition including 100 parts by mass in total of (A) polypropylene-based resin and (B) polyphenylene ether resin, 1 part to 20 parts by mass of (C) an admixture, and 0.01 parts to 0.5 parts by mass of (D) one or more compounds selected from the group consisting of a higher fatty acid, a higher fatty acid metal salt, and a higher fatty acid ester, wherein when the resin composition is dissolved in chloroform, a proportion X_{D(B+C)} of the component (D) present in a whole fraction of 100 mass % dissolved in the chloroform is 0.13 mass % to 0.80 mass %, the method comprising:
a first step of melt-kneading the whole component (B), the whole component (C), and 15 mass % to 100 mass % of the component (D) to obtain kneaded material; and
a second step of adding the whole component (A) and the rest of the component (D) (except in the case where the whole component (D) is added in the first step to the kneaded material obtained in the first step, and melt-kneading them.

2. The method of manufacturing a resin composition according to claim 1,
wherein the following relationship is satisfied:
6,000≥[{Y_{(D)}−X_{D(B+C)}×(Y_{(B)}Y_{(C)})/100}/Y_{(A)}]×10⁶≥500
where Y_{(A)}, Y_{(B)}, Y_{(C)}, and Y_{(D)} are respective contents, in parts by mass, of the components (A), (B), (C), and (D) with respect to 100 parts by mass of the components (A) and (B) in total.

3. The method of manufacturing a resin composition according to claim 1,
wherein a content of the component (A) is 30 parts to 98 parts by mass with respect to 100 parts by mass of the components (A) and (B) in total.

4. The method of manufacturing a resin composition according to claim 1,
wherein the component (D) is the higher fatty acid metal salt.

5. The method of manufacturing a resin composition according to claim 1,
wherein the component (C) is one or more selected from the group consisting of a hydrogenated block copolymer, a copolymer having a polystyrene block chain-polyolefin block chain, and a copolymer having a polyphenylene ether block chain-polyolefin block chain.

6. A method of manufacturing a resin composition including 100 parts by mass in total of (A) polypropylene-based resin and (B) polyphenylene ether resin, 1 part to 20 parts by mass of (C) an admixture, and 0.01 parts to 0.5 parts by mass of (D) one or more compounds selected from the group consisting of a higher fatty acid, a higher fatty acid metal salt, and a higher fatty acid ester, wherein when the resin composition is dissolved in chloroform, a proportion X_{D(B+C)} of the component (D) present in a whole fraction of 100 mass % dissolved in the chloroform is 0.13 mass % to 0.80 mass %, the method comprising:
a first step of melt-kneading part of the component (A), the whole component (B), the whole component (C), and 15 mass % to 100 mass % of the component (D) to obtain kneaded material, and
a second step of adding the rest of component (A) and the rest of the component (D) (except in the case where the whole component (D) is added in the first step to the kneaded material obtained in the second step, and melt-kneading them.

7. The method of manufacturing a resin composition according to claim 6,
wherein the following relationship is satisfied:
6,000≥[{Y_{(D)}−X_{D(B+C)}×(Y_{(B)}+Y_{(C)})/100}/Y_{(A)}]×10⁶≥500
where Y_{(A)}, Y_{(B)}, Y_{(C)}, and Y_{(D)} are respective contents, in parts by mass, of the components (A), (B), (C), and (D) with respect to 100 parts by mass of the components (A) and (B) in total.

8. The method of manufacturing a resin composition according to claim 6,
wherein a content of the component (A) is 30 parts to 98 parts by mass with respect to 100 parts by mass of the components (A) and (B) in total.

9. The method of manufacturing a resin composition according to claim 6,
wherein the component (D) is the higher fatty acid metal salt.

10. The method of manufacturing a resin composition according to claim 6,
wherein the component (C) is one or more selected from the group consisting of a hydrogenated block copolymer, a copolymer having a polystyrene block chain-polyolefin block chain, and a copolymer having a polyphenylene ether block chain-polyolefin block chain.
